(19) United States
(12) Patent Application Publication
(10) Pub. No.: US 2017/0146723 A1
(43) Pub. Date: May 25, 2017

(54) LIQUID CRYSTAL DISPLAY AND BACKLIGHT MODULE

(71) Applicant: Shenzhen China Star OPtoelectonics Technology Co., Ltd., Guangdong (CN)

(72) Inventor: Yong FAN, Guangdong (CN)

(21) Appl. No.: 14/776,290

(22) PCT Filed: Aug. 20, 2015
(86) PCT No.: PCT/CN2015/087704

§ 371 Date: Sep. 14, 2015

(30) Foreign Application Priority Data
Jul. 3, 2015 (CN) 201510391763.8

(51) Int. Cl. F21V 8/00

(52) U.S. Cl. CPC G02B 6/0068; G02B 6/0091

(57) ABSTRACT

A backlight module which includes: a light guide plate having a first light incident side surface, a second light incident side surface and a third light incident side surface; wherein the second light incident side surface is connected to the first light incident side surface, the third light incident side surface is connected to the first light incident side surface, and the second light incident side surface is opposite to the third light incident side surface; and light source assemblies respectively disposed at a position opposite to the first light incident side surface, a position opposite to the second light incident side surface and a position opposite to the third light incident side surface. A liquid crystal display having the backlight module is also disclosed. The liquid crystal display and the backlight module thereof of the present disclosure improve optical couple efficiency while thinning a display.

### TECHNICAL FIELD

The present disclosure relates to a liquid crystal display technical field, more particularly, to a liquid crystal display and a backlight module thereof.

### BACKGROUND ART

With the development of a liquid crystal display towards a large size, 4K Ultra HD, even 8K Ultra HD, the number of pixels increases, it leads the sizes of pixels and the pixel aperture ratio to be reduced, and the penetration rate is hereby lowered. Since the penetration ratio of a liquid crystal display panel is lowered, the luminance of a backlight light source provided by a backlight module needs to increase therewith.

In a backlight module, if a single long edge side-incident type is adopted, the luminance of the backlight light source provided by the backlight module is difficult to meet the requirement due to limitation for luminance and heat dissipation of a light emitting diode, thus, a double short edge or double long edge side-incident type is generally adopted currently. In a backlight module adopting a double short edge or double long edge side-incident type, since a light guide plate is heated and absorbs moisture and expands, an optical couple distance between the light emitting diode and the light guide plate will increase in order to avoid the light guide plate to warp to generate uneven luminance and avoid the light guide plate to expand to crash the light emitting diode to reduce risks of warping and crashing the light. However, the optical couple efficiency will greatly reduce due to increase of the optical couple distance.

In addition, a trend of thinning liquid crystal display has become increasingly obvious, the design of the traditional double short edge or double long edge side-incident type is difficult to sharply thin the body.

### SUMMARY

In order to solve the above problem existing in the prior art, the present disclosure aims to provide a backlight module which includes: a light guide plate having a first light incident side surface, a second light incident side surface and a third light incident side surface; wherein the second light incident side surface is connected to the first light incident side surface, the third light incident side surface is connected to the first light incident side surface, and the second light incident side surface is opposite to the third light incident side surface; and light source assemblies respectively disposed at a position opposite to the first light incident side surface, a position opposite to the second light incident side surface and a position opposite to the third light incident side surface.

Further, one end of the light source assembly disposed at the position opposite to the second light incident side surface is placed at a junction between the second light incident side surface and the first light incident side surface.

Further, one end of the light source assembly disposed at the position opposite to the third light incident side surface is placed at a junction between the third light incident side surface and the first light incident side surface.

Further, the length of the light source assembly disposed opposite to the second light incident side surface does not exceed 60 percentage of the length of the second light incident side surface.

Further, the length of the light source assembly disposed opposite to the third light incident side surface does not exceed 60 percentage of the length of the third light incident side surface.

Further, the light source assembly includes: a power supply plate and point light sources space-disposed on the power supply plate.

Further, the light source assembly further includes: a space holder disposed on the power supply plate and between two point light sources, and the space holder abuts against the opposite light incident side surface.

Further, the power supply plate is a printed circuit board.

Further, the point light source is a light emitting diode.

Another purpose of the present disclosure provides a liquid crystal display device, which includes a backlight module and a liquid crystal display panel that are oppositely disposed, the backlight module provides a display light source for the liquid crystal display panel.

The liquid crystal display and the backlight module thereof of the present disclosure improve optical couple efficiency while thinning a display.

### BRIEF DESCRIPTION OF THE DRAWINGS

These and/or other aspects, characteristics and advantages of the embodiments in the disclosure will become more apparent from the following description, taken in conjunction with the accompanying drawings in which:

FIG. 1 is an schematic top view of a backlight module according to an exemplary embodiment of the present disclosure;

FIG. 2 is a sectional-tangental view of an A-A direction in FIG. 1; and

FIG. 3 is a structural schematic diagram of a liquid crystal display device according to an embodiment of the present disclosure.

### DETAILED DESCRIPTION OF EXEMPLARY EMBODIMENTS

Embodiments of the present disclosure will be described in detail below by referring to the accompany drawings. However, the present disclosure can be implemented in different manners and should not be interpreted to be confined to the specific embodiments elaborated hereby. Instead, these embodiments are provided for explaining the principle and actual application of the present invention, thus other skilled in the art can understand various embodiments and amendments which are suitable for specific intended applications of the present disclosure. In the drawings, for components being clear, thicknesses of layers and areas are exaggerated, and the same reference signs may be used to indicate the same element in the whole description and drawings.

It should be understand that even if terms “first”, “second” and “third”, etc., may be used here to describe various elements, but these elements should not be limited to these terms. These terms are merely used to distinguish one element from another element.

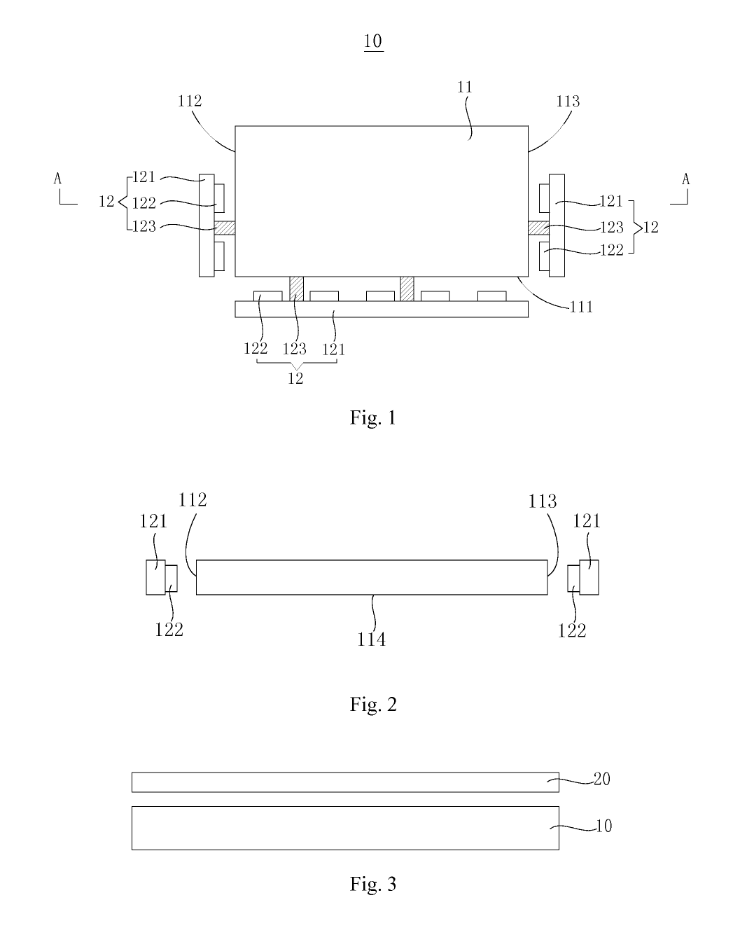

FIG. 1 is an schematic top view of a backlight module according to an exemplary embodiment of the present disclosure. FIG. 2 is a sectional-tangental view of an A-A direction in FIG. 1.

Referring to FIGS. 1 and 2, a backlight module 10 according to an embodiment of the present disclosure includes: a light guide panel 11 and a light source assembly 12. It should be explained that the backlight module 10 according to an embodiment of the present disclosure may further include a back plate, a plastic frame, an optical film sheet, a reflective sheet and other appropriate components, but these components are not emphasis of the present disclosure, which are not described any more herein, and those skilled in the art may refer to the specific structure of the backlight module of the prior art to obtain these components.

In the present embodiment, the whole light guide plate 11 has a rectangle shape, but the present disclosure is not limited hereto. The light guide plate 11 includes: a first light incident side surface 111, a second light incident side surface 112 and a third light incident side surface 113; wherein the second light incident side surface 112 is connected to one end of the first light incident side surface 111, the third light incident side surface 113 is connected to another end of the first light incident side surface 111, and the second light incident side surface 112 is opposite to the third light incident side surface 113. Here, the first light incident side surface 111 is a long side surface of the light guide plate 11, while the second light incident side surface 112 and the third light incident side surface 113 are both short side surfaces, but the present disclosure is not limited hereto.

Light source assemblies 12 are disposed at a position opposite to the first light incident side surface 111, a position opposite to the second light incident side surface 112 and the third light incident side surface 113, respectively. In the present embodiment, the light source assembly 12 includes: a power supply plate 121 and point light sources 122 space-disposed on the power supply plate 121. Here, the power supply plate 121 may be a printed circuit board (PCB), but the present disclosure is not limited hereto; The point light source 122 may be a light emitting diode (LED), but the present disclosure is not limited hereto.

In addition, one end of the light source assembly 12 (i.e., one end of the power supply plate 121) at the position opposite to the second light incident side surface 112 is placed at a junction between the second light incident side surface 112 and the first light incident side surface 111. Further, the length of the light source assembly 12 (i.e., the length of the power supply plate 121) at the position opposite to the second light incident side surface 112 does not exceed 60 percentage of the length of the second light incident side surface 112 to avoid affecting the thinning of the liquid crystal display.

In addition, one end of the light source assembly 12 (i.e., one end of the power supply plate 121) at the position opposite to the third light incident side surface 113 is placed at a junction between the third light incident side surface 113 and the first light incident side surface 111. Further, the length of the light source assembly 12 (i.e., the length of the power supply plate 121) at the position opposite to the third light incident side surface 113 does not exceed 60 percentage of the length of the third light incident side surface 113 to avoid affecting the thinning of the liquid crystal display.

Further, in the present embodiment, in order to maintain a spacing distance between the light source assembly 12 and the opposite light incident side surface, the light source assembly 12 further includes: a space holder 123; wherein the space holder 123 is disposed on the power supply plate 121 and between two point light sources 122, and the space holder 123 stands against and contact the opposite light incident side surface. For example, the space holder 123 of the light source assembly 12 at the position opposite to the first light incident side surface 111 stands against and contact the first light incident side surface 111; the space holder 123 of the light source assembly 12 at the position opposite to the second light incident side surface 112 stands against and contact the second light incident side surface 112; and the space holder 123 of the light source assembly 12 at the position opposite to the third light incident side surface 113 stands against and contact the third light incident side surface 113.

In addition, in order to enable the backlight light source emitted by the backlight module 10 to be even, in the present embodiment, some lattice points (not illustrated) may be disposed at the bottom surface 114 of the light guide plate 11, wherein the density of lattice points at a position closing to the light source assembly 12 is relatively low, while the density of lattice points at a position far away from the light source assembly 23 is relatively large.

FIG. 3 is a structural schematic diagram of a liquid crystal display device according to an embodiment of the present disclosure.

Referring to FIG. 3, the liquid crystal display according to an embodiment of the present disclosure includes liquid crystal panels 20 that are oppositely disposed and the backlight module 10 as illustrated in FIGS. 1 and 2, wherein the backlight module 10 provides an even backlight light source for the liquid crystal panel 20 to enable the liquid crystal panels 20 to display an image.

To sum up, the liquid crystal display and the backlight module thereof of the present disclosure improve optical couple efficiency while thinning a display.

Although the present disclosure is described with reference to the special exemplary embodiments, it will be understood by those skilled in the art that various changes in form and details may be made therein without departing from the spirit and scope of the present invention as defined by the following claims and its equivalents.

1. A backlight module, comprising:
a light guide plate having a first light incident side surface, a second light incident side surface and a third light incident side surface; wherein the second light incident side surface is connected to the first light incident side surface, the third light incident side surface is connected to the first light incident side surface, and the second light incident side surface is opposite to the third light incident side surface; and
light source assemblies respectively disposed at a position opposite to the first light incident side surface, a position opposite to the second light incident side surface and a position opposite to the third light incident side surface.

2. According to the backlight module of claim 1, one end of the light source assembly disposed at the position opposite to the second light incident side surface is placed at a junction between the second light incident side surface and the first light incident side surface.

3. According to the backlight module of claim 1, one end of the light source assembly disposed at the position opposite to the third light incident side surface is placed at a junction between the third light incident side surface and the first light incident side surface.

4. According to the backlight module of claim 2, wherein the length of the light source assembly disposed opposite to the second light incident side surface does not exceed 60 percentage of the length of the second light incident side surface.

5. According to the backlight module of claim 3, wherein the length of the light source assembly disposed opposite to the third light incident side surface does not exceed 60 percentage of the length of the third light incident side surface.

6. The backlight module of claim 1, wherein the light source assembly comprises: a power supply plate and point light sources space-disposed on the power supply plate.

7. The backlight module of claim 6, wherein the light source assembly further comprises: a space holder disposed on the power supply plate and between two point light sources, and the space holder abuts against the opposite light incident side surface.

8. The backlight module of claim 6, wherein the power supply plate is a printed circuit board.

9. The backlight module of claim 6, wherein the point light source is a light emitting diode.

10. A liquid crystal display, comprising a backlight module and a liquid crystal display panel that are oppositely disposed, the backlight module providing a display light source for the liquid crystal display panel, wherein the backlight module comprises:
a light guide plate having a first light incident side surface, a second light incident side surface and a third light incident side surface; wherein the second light incident side surface is connected to the first light incident side surface, the third light incident side surface is connected to the first light incident side surface, and the second light incident side surface is opposite to the third light incident side surface; and
light source assemblies respectively disposed at a position opposite to the first light incident side surface, a position opposite to the second light incident side surface and a position opposite to the third light incident side surface.

11. According to the liquid crystal display of claim 10, wherein one end of the light source assembly disposed at the position opposite to the second light incident side surface is placed at a junction between the second light incident side surface and the first light incident side surface.

12. According to the liquid crystal display of claim 10, wherein one end of the light source assembly disposed at the position opposite to the third light incident side surface is placed at a junction between the third light incident side surface and the first light incident side surface.

13. According to the liquid crystal display of claim 11, wherein the length of the light source assembly disposed opposite to the second light incident side surface does not exceed 60 percentage of the length of the second light incident side surface.

14. According to the liquid crystal display of claim 12, wherein the length of the light source assembly disposed opposite to the third light incident side surface does not exceed 60 percentage of the length of the third light incident side surface.

15. The liquid crystal display of claim 10, wherein the light source assembly comprises: a power supply plate and point light sources space-disposed on the power supply plate.

16. The liquid crystal display of claim 15, wherein the light source assembly further comprises: a space holder disposed on the power supply plate and between two point light sources, and the space holder abuts against the opposite light incident side surface.

17. The liquid crystal display of claim 15, wherein the power supply plate is a printed circuit board.

18. The liquid crystal display of claim 15, wherein the point light source is a light emitting diode.
